(19) United States
(12) Patent Application Publication
(10) Pub. No.: US 2019/0325761 A1
(43) Pub. Date: Oct. 24, 2019

(54) INFORMATION PROCESSING DEVICE, METHOD, AND PROGRAM

(71) Applicant: CANON KABUSHIKI KAISHA, Tokyo (JP)

(72) Inventor: Shinichi Ohno, Tokyo (JP)

(21) Appl. No.: 16/455,931

(22) Filed: Jun. 28, 2019

Related U.S. Application Data
(63) Continuation of application No. 14/688,622, filed on Apr. 16, 2015, now Pat. No. 9,734,727.
Application No. 14/688,622 is a continuation of application No. 11/006,620, filed on Dec. 8, 2004, now Pat. No. 9,270,843.

(30) Foreign Application Priority Data
Dec. 10, 2003 (JP) 2003-412488
Nov. 30, 2004 (JP) 2004-346344

(51) Int. Cl. G08G 5/02; G08G 5/00

(52) U.S. Cl. CPC G08G 5/025; G08G 5/0021; G08G 5/0013; G08G 5/0047

(57) ABSTRACT

An information processing device which can communicate over a network with a print control apparatus for activating a second interface unit when a print job is applied to a printer in a power-saving status which is to be activated by a specific packet, and when an first activation instruction including identification information specifying a print control apparatus to be activated is received through a first interface unit includes: first instruction control means for transmitting a first activation instruction to the print control apparatus when a print instruction is issued; and output control means for outputting a print job to the print control apparatus after establishing a communication facility of the second interface unit after transmitting the first activation instruction.

### BACKGROUND OF THE INVENTION

### Field of the Invention

The present invention relates to an information processing device, method, and program, and more specifically to a system of releasing a power-saving mode in a printer connected to a network.

### Related Background Art

Several power-saving techniques for a printer connected to a network have been conventionally proposed. For example, it can be a method of stopping power supply to a print engine unit having relatively high power consumption when a print job is not received for a predetermined time through a network interface of a printer.

In addition to the above-mentioned method, there has been a method of further improving the power-saving effect by stopping power supply to the CPU except the parts required to activate a network interface unit, etc. in the print controller unit. It can be realized by activating the CPU by issuing a signal when the network interface unit receives a predetermined packet. In this case, the activation can also be realized by a broadcast packet. Therefore, when the current apparatus is set as a destination in the packet which is an activation condition, the CPU is frequently activated in some connected networks, thereby unintentionally attenuating the power-saving effect.

Therefore, a method of setting an activation condition using a magic packet technique proposed by AMD has been suggested. For example, the technology of activating a printer from a status (status in which power is turned on) in which the printer cannot perform communications by transmitting a special packet (for example, a magic packet) from a PC to a printer 100 when a printing process is to be performed when the printer 100 is in a low power consumption status with the power saved including in the communications unit for receiving a print job is disclosed by, for example, Japanese Patent Application Laid-open No. 2002-287936.

However, by providing a proxy server with the conventional system maintained in the conventional host computer (job issuer), a special packet is communicated between a host computer and a printer. That is, in the system of directly setting a job from a host to a printer including print data, it is necessary that another apparatus or a system such as a proxy server, etc. is to be incorporated to support the host side as a special packet.

The present invention has been developed to solve the above-mentioned problems, and aims at providing a system of normally printing data by directly setting a job including print data from a job issuer to a printer device which can be activated in a state of performing various communications by receiving a specific packet.

### SUMMARY OF THE INVENTION

Accordingly, the present invention is conceived as a response to the above-described disadvantages of the conventional art.

According to one aspect of the present invention, preferably, an image forming apparatus is an information processing device which performs communications over a network with a print control apparatus for activating a second interface unit when a first activation instruction including identification information specifying a print control apparatus to be activated is received through a first interface unit, and includes: a first instruction control means for transmitting a first activation instruction to a print control apparatus upon input of a print instruction; and an output control means for outputting a print job to the print control apparatus after establishing a communications function of a second interface unit after transmission of first activation instruction.

Other features and advantages of the present invention will be apparent from the following description taken in conjunction with the accompanying drawings, in which like reference characters designate the same or similar parts throughout the figures there.

### BRIEF DESCRIPTION OF THE DRAWINGS

FIG. 1 shows an example of the configuration of the entire system;

FIG. 2 shows an example of the configuration of the control unit of a printer;

FIG. 3 shows an example of the configuration of the network interface unit in the control unit of the printer;

FIG. 4 is a graph for explanation of plural types of examples of power consumption in the printer control unit;

FIG. 5 shows an example of the configuration of the function block of the software operating on the host computer;

FIG. 6 shows an example of a user interface of the software operating on the host computer;

FIG. 7 shows an example of an activation packet for releasing a non-energized part of a printer control unit and establishing a communications function;

FIG. 8 is a flowchart showing an example of the operation of the print driver operating on the host computer in search of a printer;

FIG. 9 is a flowchart showing an example of the operation performed in response to a search packet of the printer control unit;

FIG. 10 shows an example of a block diagram of a search/reply packet;

FIG. 11 is a flowchart for explanation of an example of the procedure of generating a logical printer in a host computer;

FIG. 12 is a flowchart showing an example of the operation of transmitting a print job from a host computer;

FIG. 13 is a flowchart for explanation of an example of an operation performed on external access in the printer control unit;

FIG. 14 is a flowchart showing an example of an operation performed when the host computer issues a status request;

FIG. 15 shows an example of the configuration of the control unit in a printer;

FIG. 16 is a flowchart for explanation of an example of an operation performed on external access in the printer control unit;

FIG. 17 is a flowchart for explanation of an example of an operation performed on external access in the printer control unit;

FIG. 18 shows an example of the configuration of the functions of the software operating on the host computer;

FIG. 19 shows an example of the operation performed when a specific pattern is issued addressed to a non-specific device registered in the print control apparatus from the host computer in the printing system;

FIG. 20 shows an example of a specific pattern addressed to a non-specific device registered in the print control apparatus;

FIGS. 21A and 21B are flowcharts showing examples of the operation of the host computer and the printer control unit; and

FIG. 22 shows an example of a user interface of software operating on the host computer.

### DESCRIPTION OF THE PREFERRED EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

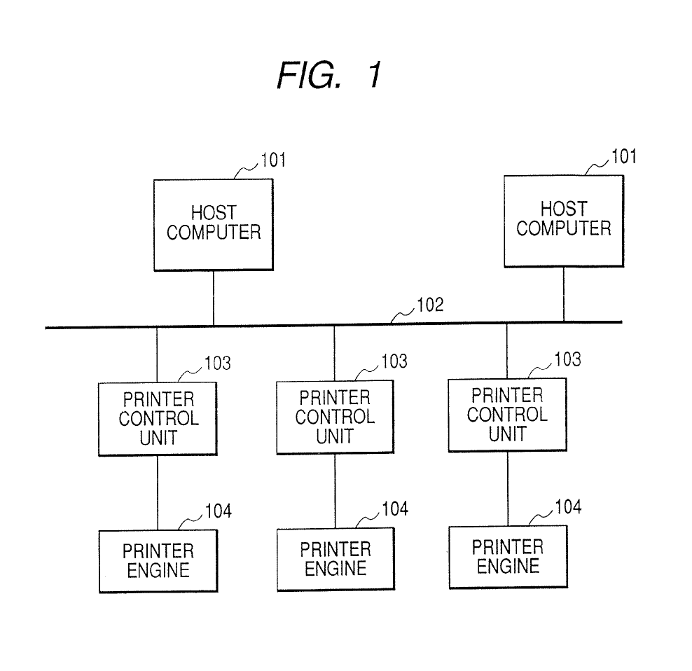

FIG. 1 shows the configuration of an embodiment of the present invention. In FIG. 1, a host computer 101 is connected to a network 102, and performs various processes. The network 102 is indicated as a local area network in this embodiment, but it is not limited to this type of network, and can be any other networks capable of attaining the advantage of the present invention, for example, a wireless LAN, etc. A printer control unit 103 performs a received print job by connecting to the network 102, and performs printing by a printer engine 104 connected to the printer control unit 103.

Described below is a printing operation. In a normal printing operation, the host computer 101 generates a print job, and transmits it to a desired printer control unit 103 over the network 102. Upon receipt of a print job from the host computer 101, the printer control unit 103 issues an instruction to the printer engine 104 to perform printing according to a print job.

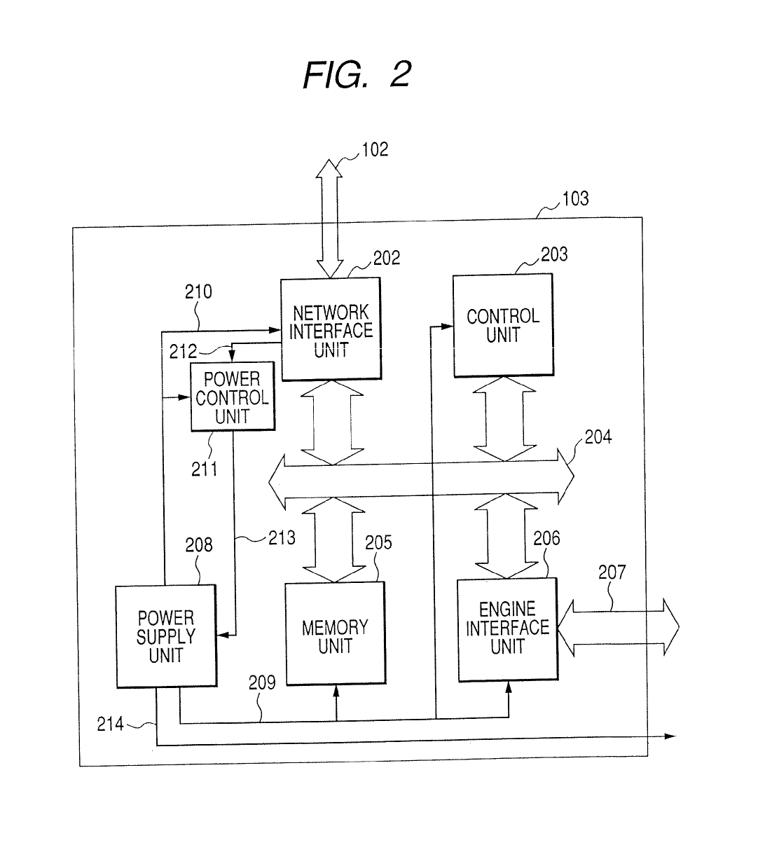

FIG. 2 shows the configuration of the printer control unit according to an embodiment of the present invention. In FIG. 2, a network interface unit 202 is used for connection to the network 102. A control unit 203 controls the printer control unit 103, and is connected to an internal bus 204, a memory unit 205 for temporarily storing a program operating on the control unit 203, a print job, and information as a work area, an engine interface unit 206 connected to the printer engine 104, and an engine interface bus 207 communicating image information with the printer engine 104. A power supply unit 208 for supplying power to each unit provides power for the control unit 203, the memory unit 205, the engine interface unit 206, and the printer engine 104. A first power supply line 210 constantly supplies power to the network interface unit 202 and a power control unit 211. A second power supply line 209 stops supplying power in the second power status and the third power status described later. A third power supply line 214 provides power for the printer engine unit when a print job is applied. They are controlled by a activation signal 212 from the network interface unit 202 and a power control signal 213 for controlling the power supply unit 208.

In the first power status, the first power supply is performed, but the second power supply is not performed, thereby realizing the power-saving operation. In the power-saving operation, power is supplied only to the network interface unit 202 and the power control unit 211, and an activation packet for return to the second power status is continuously awaited. When an activation packet is received, the activation signal 212 enters the power control unit 211. Upon receipt of the activation signal 212, the power control unit 211 issues to the power supply unit 208 an instruction to supply the second power supply line 210 using the power control signal 213, and power is also supplied to each unit other than the network interface unit 202 and the power control unit 211, and the second power status is restored. In the present embodiment, each unit shown in the attached drawings is provided with power and activated, but it is also possible to activate only necessary portion to attain the advantage of the present invention and enhance the power-saving effect. When it is determined in the second power status that the data of a print job is externally received, the power control is performed to enter the third power status. On the other hand, if only the status such as the remainder of toner, etc. is externally received without receiving the data of the print job in the second power status, then it is not necessary to necessarily pass control to the third power status, but a status reply can be made with the second power status maintained.

In the third power status, at least the second power status and the third power status are supplied, and the subsequent normal operations are performed. That is, upon receipt of a packetized print job from the network 102, the network interface unit 202 writes it to the work area of the memory unit 205. After restoring the packetized print job to a print job based on the network protocol, the control unit 203 expands it into image data, transmits it to the printer engine 104 through the engine interface unit 206 and the engine interface bus 207, and prints the data.

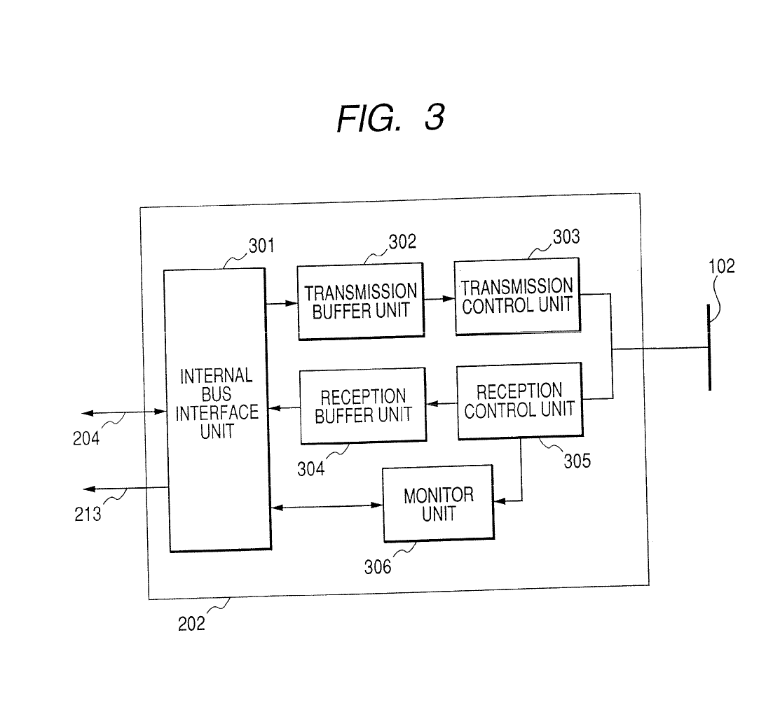

FIG. 3 shows the configuration of the network interface unit 202 on the printer according to the first embodiment of the present invention. In FIG. 3, an internal bus interface unit 301 is connected to the internal bus 204, and a transmission buffer unit 302 temporarily stores the transmission data. A transmission control unit 303 controls the transmission of a packet to a network, and a reception buffer unit 304 temporarily stores the received data. A reception control unit 305 controls the reception of a packet from a network. A monitor unit 306 monitors whether or not a received packet in the reception control unit matches a predetermined condition.

Described below are the operations. In the transmission of data in the third power status, the data packetized through the internal bus interface unit 301 is stored in the transmission buffer unit 302, and the transmission control unit 303 transmits the packet data to the network 102 based on the network protocol. Similarly, in the reception of data, the reception control unit 305 stores the packet data received based on the network protocol from the network 102 in the reception buffer unit 304, and writes it to the memory unit 205 through the internal bus interface unit 301.

In the first power status, only the function on the reception side is effective (the portion engaged in the transmission of data is not energized, thereby improving the power-saving effect), and the monitor unit 306 monitors the packet data received by the reception control unit 305 whether or not it matches a predetermined condition. If they match, it is informed to the power control unit 211 by the power control signal 213 through the internal bus interface unit 301.

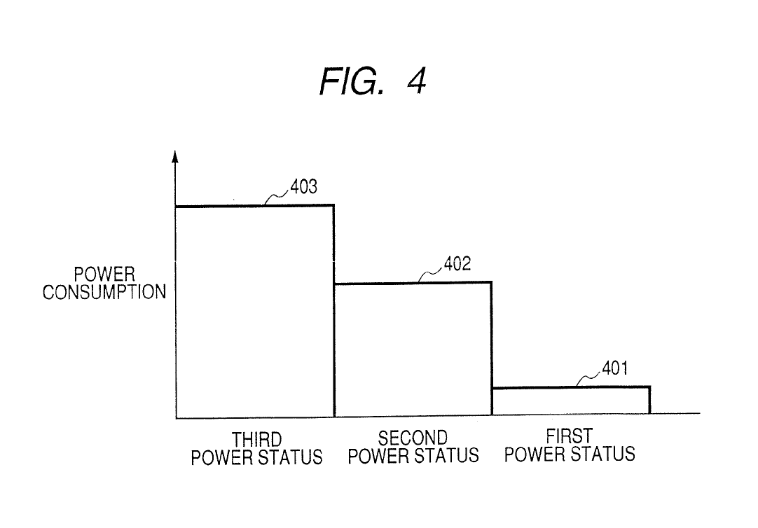

FIG. 4 is a graph for explanation of the phase of the power consumption of the printer control unit 103 according to the present invention. A first power status 401 indicates the power consumption status (power supply status) corresponding to the case in which only the activation of the network interface unit 202 which is the first network unit is performed, and the second highest power-saving effect after the case in which the power is turned off can be obtained.

A second power status 402 indicates the power consumption status (power supply status) when the printer controller (second interface unit) is activated in cooperation with the activation of the network interface unit 202 (first interface unit). By the activation of the printer controller, various communications with the external information processing device can be established. For example, a job can be received including the print data, and various statuses can be communicated. When the printer controller is considered with reference to FIG. 2, the network interface unit 202, the control unit 203, the memory unit 205, etc. required in the communications function correspond to it, but portions capable of communicating various statuses and print jobs can also be included.

The printer controller in the present embodiment can be divided into a communications control unit and a print processing unit for interpreting and expanding print data. Assuming that the power consumption of the second power status 402 is required when the communications control unit except the print processing unit is activated, the power consumption can be further reduced. Especially, when a request for a status from an external device, etc. is received, only the communications control unit can be activated.

A third power status 403 indicates the power consumption status (power supply status) required in the recording operation based on the job including print data, and corresponding to the preparing operation (for example, power supply to a fixer, and start of drive of a polygon motor) for a recording operation.

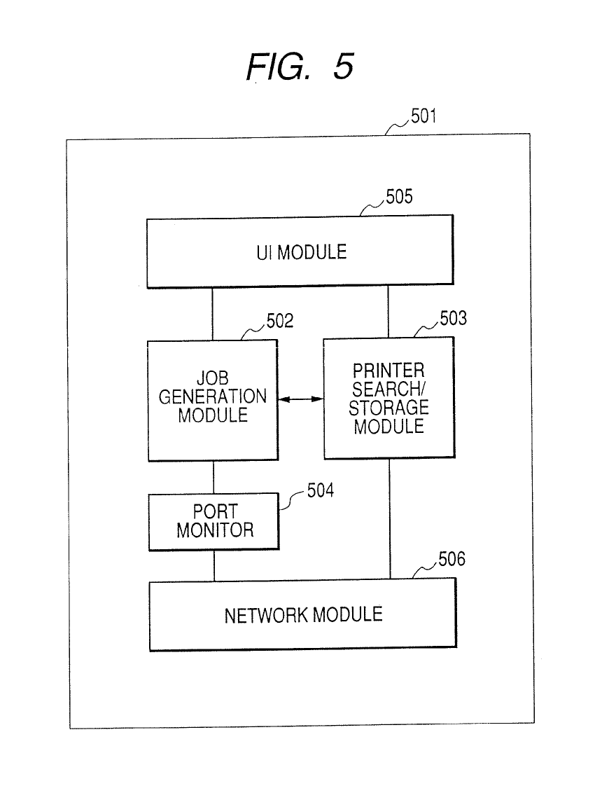

FIG. 5 shows the configuration of the print processing module including the print driver operating on the host computer 101. In FIG. 5, a print processing module 501 operates on the host computer 101. A job generation module 502 generates a print job, and a port monitor 504 interfaces between a printing service in which print data generated by the job generation module is processed and an actual printer. The port monitor 504 is assumed to store the settings of the output port associated with an IP address and a MAC address for each logical printer set for a client. That is, generating a port monitor 504 refers to making settings for an output port only or settings including an output port. An output port refers to a port on the software formed for a client for connection between a logical printer and an actual printer.

A printer search/storage module 503 transmits a search packet of the printer control unit 103 at the time of installation or with any timing, and stores the printer control unit 103 in the internal list. Although a search target is the printer control unit 103, the printer control unit 103 can be a printer including the printer control unit 103 and the printer engine 104.

A network module 506 communicates data with the job generation module 502 and the printer search/storage module 503 connected to a network. The network module 506 can transmit a magic packet as an Ethernet (registered trademark) frame by having the communication facility at a TCP/IP level using a socket interface and the function of directly controlling a link layer driver. The function of the network module 506 can be independently provided, the function of an operating system such as Windows (registered trademark) can be conveniently used, or the function of an operating system and an independent function can be cooperatively used.

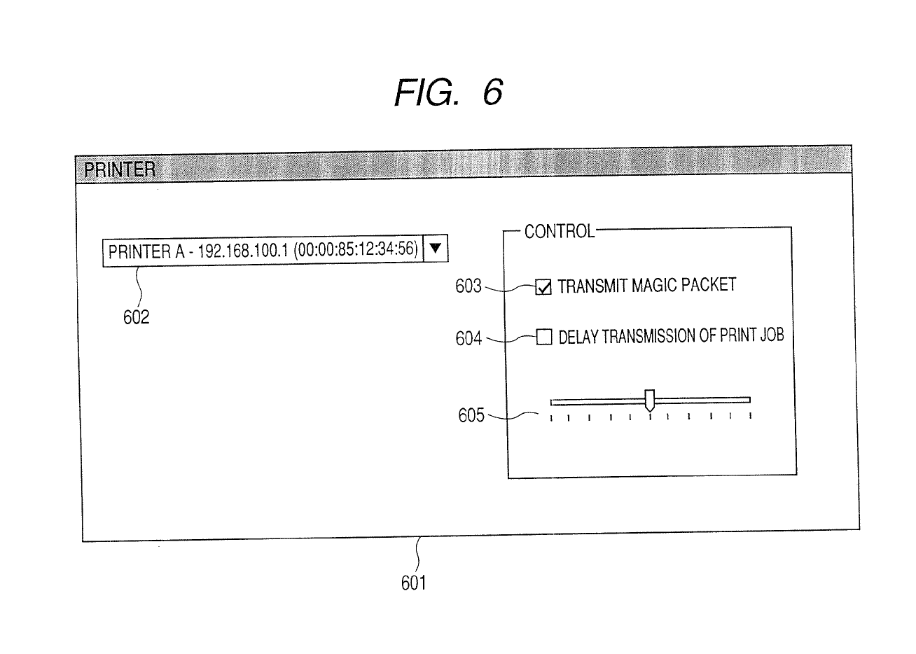

A UI module 505 inputs an instruction of a user by displaying the driver dialog screen 601 shown in FIG. 6. The UI module 505 also has the function of display the management utility screen for monitor of various statuses of the printer itself and the status of the print job in the printer.

FIG. 6 shows an example of a user interface of a print driver operating on the host computer. In FIG. 6, a driver dialog screen 601 is displayed when the user prints data, and a printer for printing data is selected on a printer selection pull-down menu 602. A magic packet transmission check box 603 is used in selecting whether or not a magic packet is transmitted when a print job is transmitted. A print job delay check box 604 is used in selecting whether or not a print job is delayed and transmitted after transmitting a magic packet. A time selection slider 605 is used in selecting a time delayed when the print job delay check box 604 is selected.

The user selects the printer control unit 103 for controlling the printer to be used from the printer selection pull-down menu 602. In the embodiments other than the present embodiment, an item for input of information about the printer control unit 103 can be used in directly inputting the information from the keyboard. The information to be input can be an IP address, a printer name, a product name, a product code, a MAC address, the URL of a printer, etc.

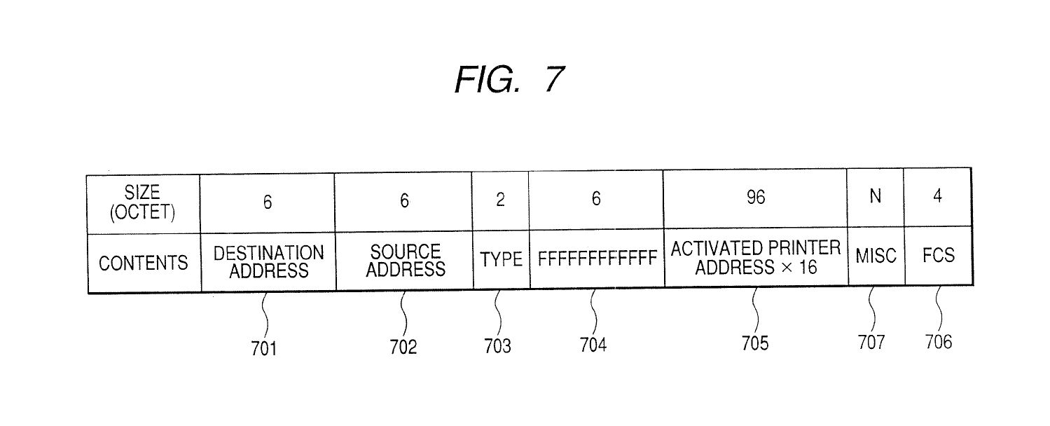

FIG. 7 shows the format of a magic packet which is an example of an activation packet according to the present invention. In FIG. 7, a destination address field 701 indicates the MAC address of a destination, and a source address field 702 indicates the MAC address of a source. A type field 703 indicates an upper protocol, and data fields 704 and 705 indicate data specific to a magic packet. The data field 704 contains a synchronized stream “FFFFFFFFFFFF”, and the data field 705 contains the value indicating the MAC address of the activated printer 16 times continuously. A data field 707 is a misc field, and its value and size are not determined. A data field 706 is an FCS field indicating the value of a CRC (cyclic redundancy check).

The activation packet is not limited to the packet in the above-mentioned format. For example, the present invention can also be realized by a packet in an independently prescribed format. It is also possible to simultaneously activate a plurality of printer control units 103 by setting the value indicating the MAC address of the activated printer in the data field 705 as a broadcast address. In this case, a broadcast address can be set as an activation condition in the monitor unit 306 of the network interface unit 202. In the present embodiment, a magic packet is used as an activation packet, but it is not limited to this packet, and any packet having the similar function can be used.

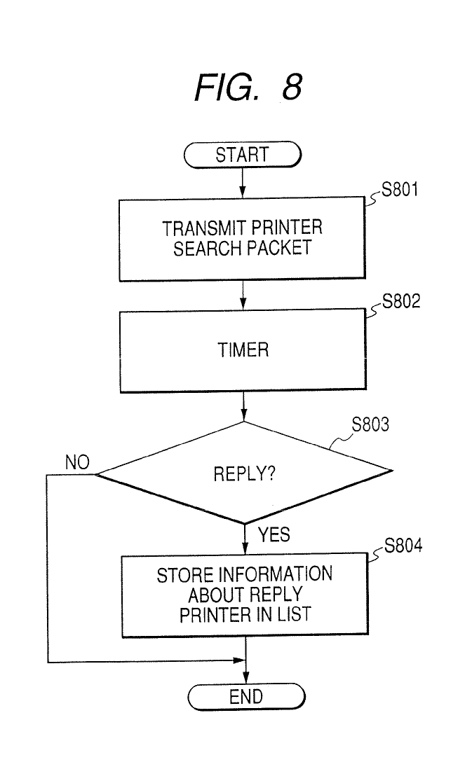

FIG. 8 is a flowchart of the operation performed when a printer of the print driver operating on the host computer 101 of the present invention is searched for. It is obvious that not only a print driver, but also another software module can takes over the process.

The search packet described later as shown in FIG. 8 is transmitted to a printer on a network by a broadcast (S801), and the second interface unit of the plurality of printer control units 103 connected to the network can be activated according to an instruction from the host computer.

For example, it is determined that there is a reply (S803) after the passage of a predetermined time set by the time selection slider 605 (S802). When there are replies from all or a part of a plurality of printers, the identification information (MAC address and other information) about each printer which returns a reply is stored in an internal list (S804). When no reply is obtained, the process terminates.

By using a UDP (user datagram protocol) in the transmission of a search packet, in transmitting a search packet, the search can be made although the host computer 101 and the printer control unit 103 are in a network over each subnet.

When the IP address of the printer control unit 103 is determined by any method, the MAC address of the corresponding printer control unit 103 can be obtained by transmitting an ARP (address resolution protocol) packet to the printer control unit 103 in the subnet, and receiving the reply packet.

However, the printer control unit 103 in the power-saving status when a search packet is transmitted cannot return a reply in response to the search packet. Therefore, before transmitting a search packet, a magic packet whose address of an activated printer is set as a broadcast address is set as a second activation instruction, transmitted by a broadcast, and a plurality of printer control units 103 are returned to the second power status, and then a search packet is transmitted, thereby obtaining a reply. Furthermore, since synchronized stream data 704 of a magic packet and the data field 705 indicating the MAC address of an activated printer can be arranged anywhere. Therefore, the activation and the search can be simultaneously performed by including them in a part of the search packet.

When the printer control unit 103 which is turned off when a search packet is transmitted is turned on later, it cannot obtain the information about the printer control unit 103 as is. However, there is the possibility that the printer control unit 103 can transmit a cold start trap packet of the SNMP (simple network management protocol) to the network at the time of power-up and reset. Using this function, the host computer 101 can determine that the printer control unit 103 has been activated. Therefore, the information about the printer control unit 103 can be obtained by transmitting a search packet to the printer control unit 103.

Thus, according to the present embodiment, not only the first activation instruction to transfer the status from the first power status in which only the network interface unit of the printer control unit 103 is activated to the second power status, but also the second activation instruction can be issued to a plurality of printer control units 103. Therefore, although the identification information about a fixed item, for example, a MAC address, etc. is not held on the host side, the printer control unit 103 can be activated from the first power status to the second power status.

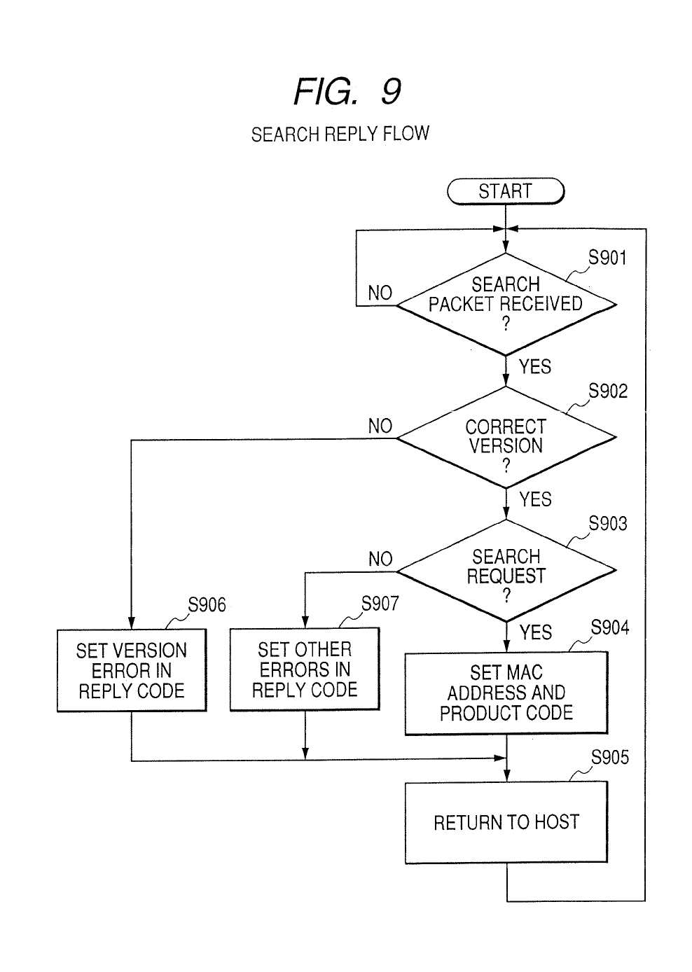

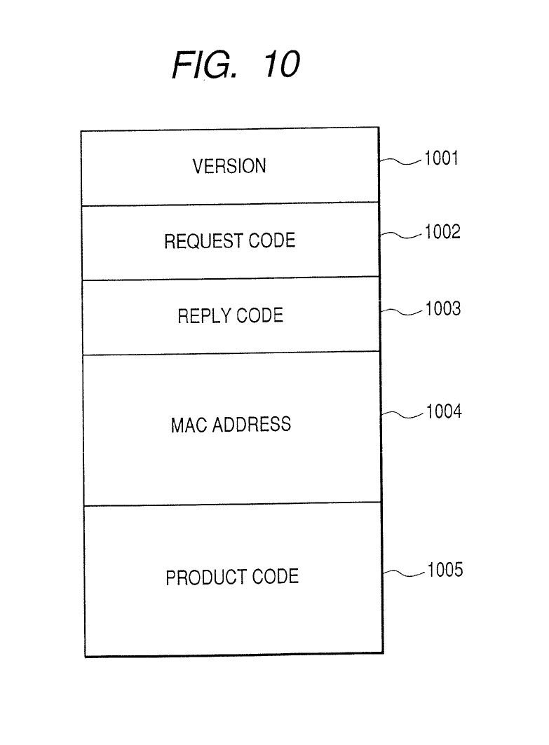

FIG. 9 is a flowchart of the operation in response to a search packet of the printer control unit 103 according to the present invention. In FIG. 9, control enters the loop (S901) until the search packet transmitted from the host computer 101 is received. Upon receipt of the packet, it is determined whether or not the value of a version field 1001 (FIG. 10) matches the corresponding version of the home apparatus (S902). If they do not match each other, then a reply code field 1003 is set to 1 (version error) (S906), and control is returned (S905) to the start of the process. On the other hand, when they match each other, it is determined whether or not the value of a request code field 1002 matches 0 (search) (S903). If they do not match, the reply code field 1003 is set to 2 (other errors) (S907), and control is returned (S905) to the start of the process. If they match each other, the reply code field 1003 is set to 0 (success in matching), and the identification information (MAC address, product code field 1005, product code of the home apparatus, etc.) about the home apparatus is set in a MAC address field 1004 (S904), and the set identification information is returned to the search requester (S905), thereby returning control to the start of step S901.

FIG. 10 is a block diagram of a search/reply packet according to the present invention. In FIG. 10, the version field 1001 indicates a version of a packet, the request code field 1002 indicates a request code, and the reply code field 1003 indicates a reply code. The value of a request code can be, for example, 0 set by the host computer 101. The MAC address field 1004 indicates the MAC address of the printer control unit 103 which returns a reply, and the product code field 1005 indicates a product code of the printer control unit 103. In addition, for example, more detailed information can be obtained from the printer control unit 103 by adding the information about the IP address, a product name, an installation position, an administrator name, etc.

A request code can be 0 (search) indicating a request to return a reply to the printer control unit 103, and 1 (status reply) indicating a request to return a reply to the printer control unit 103.

request code:

0: search

1: status reply

A reply code can be 0 (success) indicating a request normally accepted (normally, the code is returned), and 1 (version error) indicating no matching with the version information about the version field 1001 of a request packet. 2 (other errors) indicates that other errors occur and the request cannot be accepted.

reply code:

0: success

1: version error

2: other errors

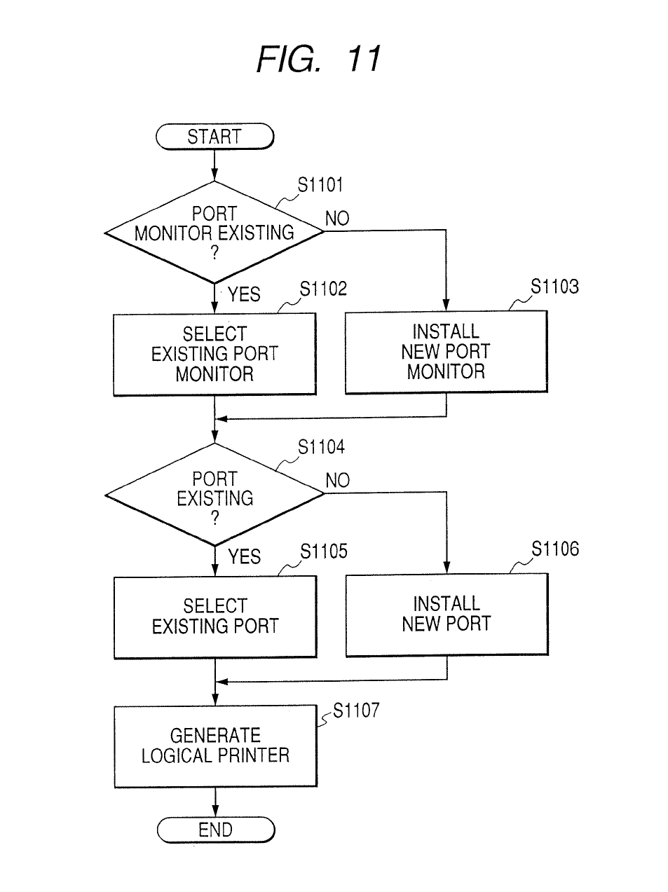

FIG. 11 is a flowchart of the procedure of generating a logical printer in the host computer 101 according to the present invention, and corresponds to the process performed for the print control unit selected in response to an instruction of a user from a plurality of print control units which return a reply based on the flowcharts shown in FIGS. 8 and 10.

In FIG. 11, it is determined whether or not there is a port monitor mapped on the communications protocol of the printer control unit selected by the host computer 101 (S1101). If there is a port, an existing port monitor is selected (S1102). If not, a port monitor is newly installed (S1103).

Then, it is determined whether or not there is a physical interface on the host computer 101 and an output port for mapping a print driver (S1104). If there is an output port, the existing port is selected (S1105). If not, an output port is newly installed (S1106). In S1105 and S1106, the identification information about the print control unit selected in response to the user instruction is extracted from the identification information (MAC address, IP address, and other information) about a plurality of printer control units obtained according to the flowchart shown in FIG. 8, and the extracted identification information is associated with an output port. Then, a logical printer for mapping a port with the print driver is generated (S1107).

Through a logical printer including the generated output port, the print driver can transmit a print job with an instruction of the identification information to activate the second interface unit to the printer control unit which is a target of the process shown in FIG. 11.

The processes in steps S1105 and S1106 are explained below in more detail. That is, the identification information (MAC address and other information) about a plurality of printer control units obtained in response to a search packet issued in the host computer 101 is stored in the internal list (S804). The printer list indicating the printer control unit which returns a reply is displayed on the display unit. The identification information corresponding to the printer control unit 103 selected in response to the user operation through the printer list is read from the internal list, and associated with the output port generated according to the flowchart shown in FIG. 11.

It is assumed that there is a logical printer for which the port monitor associated with the IP address and output port are generated. In the internal list, the MAC address and the IP address are stored as the identification information. If there is already a logical printer having a matching IP address, then the logical printer is selected for association with the identification information about the MAC address. It is also possible to associate the identification information depending on the manual operation on a desired printer selected through a user interface. In the above-mentioned process, a logical printer for instructing the printer control unit to activate the second interface unit can be easily generated when a print job is transmitted.

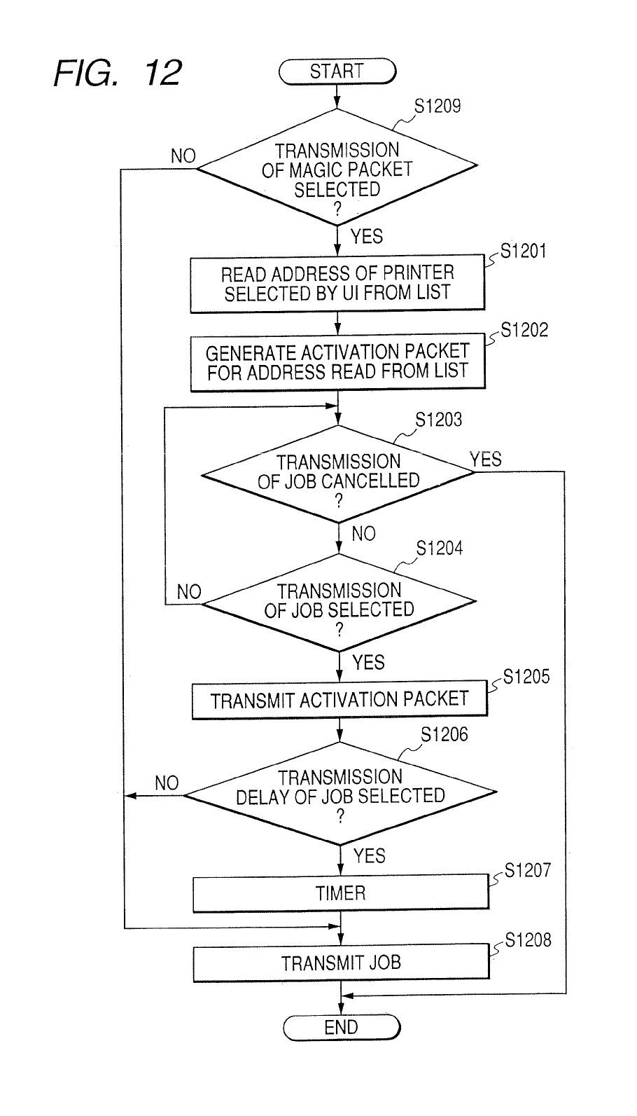

FIG. 12 is a flowchart of the operations of transmitting a print job from the host computer 101 according to the present invention. In FIG. 12, the process terminates when a permission to transmit a magic packet is not selected on the driver dialog screen 601 in FIG. 12. If it is not selected, the process in S1201 is performed (S1209). A print job refers to a process unit enclosed by a job language (Job Language: JL), etc. such as a PDL, etc.

When the user reads a MAC address corresponding to a selected printer from the internal list (S1201), inserts it into the data field 705 and the destination address field 701 of a magic packet, and an activation packet corresponding to a printer selected by a user is generated (S1202). That is, it is assumed that the host computer 101 stores a plurality of MAC addresses corresponding to a plurality of printer control units 103. When the transmission of a print job is stopped, the process terminates (S1203), and control enters a loop until the transmission of a print job is selected (S1204). When the transmission of a print job is selected, an activation packet is selected (S1205). In the process in S1205, the first activation instruction including the identification information (for example, a MAC address) specifying the printer to be activated is indicated to the printer. The printer receives the first activation instruction through the network interface unit 202, supplies power to the control unit 203, the memory unit 205, etc., thereby establishing the communication facility for communications of print data and status information. The portion for controlling the communication facility for communications of print data and status information in the printer control unit 103 is referred to as the second interface unit. As a second interface unit, a print data interpreting unit for expanding the print data written in the page description language into bit map data can be included. The network interface unit 202 is referred to as a first interface unit as compared with the second interface unit.

When the driver dialog screen 601 selects the print job delay check box 604 (S1206), a print job is transmitted (S1208) after the passage of time selected by the time selection slider 605 (S1207). The process can be performed by outputting a print job on a printer after establishing the communication facility of a printer.

When the printer control unit 103 connected to a network does not permit the power-saving status, it is not necessary to transmit a magic packet. Therefore, the process performed before transmitting the print job can be omitted by selection by the magic packet transmission check box 603. When it takes a long time from reception of an activation packet to reception of a print job, a print job can be transmitted without fail by delaying the transmission of a print job.

When the printer control unit 103 enters the status of receiving a print job after activation, a packet informing of it is transmitted to the host computer 101, and the host computer 101 can transmit a print job after receiving the information, thereby reducing the time taken to wait for the transmission of the print job.

It is also possible to specify the model of the printer control unit 103 from the information contained in the reply packet in response to the search packet, and set a transmission time predetermined for each model.

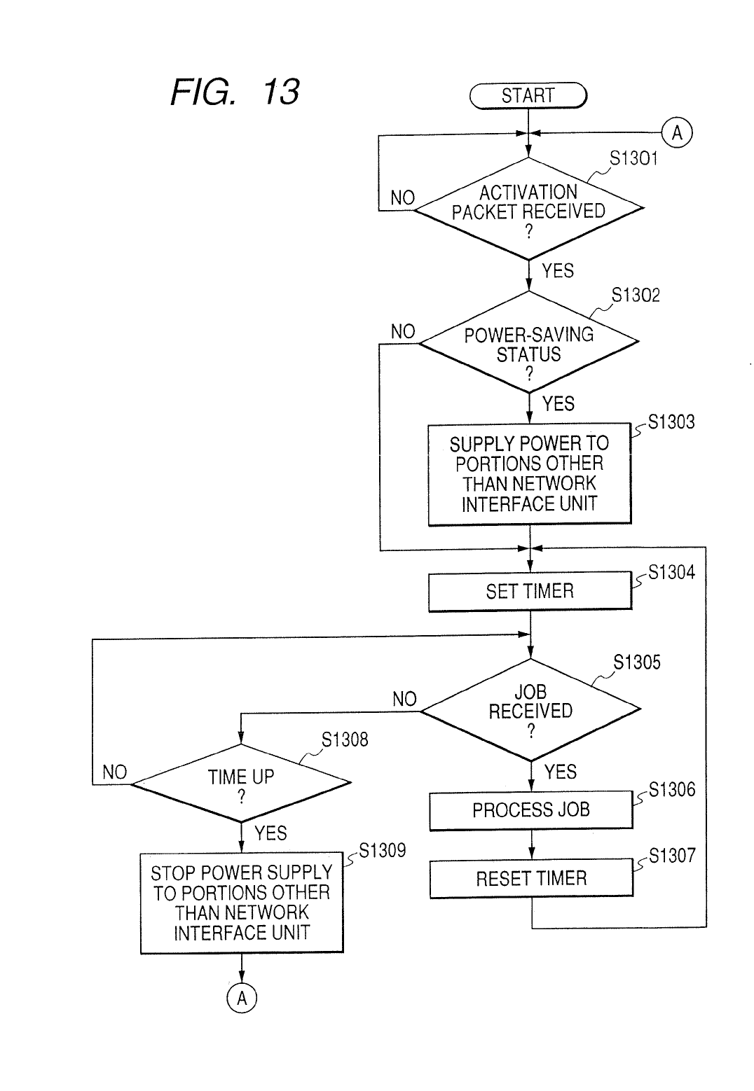

FIG. 13 is a flowchart for explanation of the operation of receiving a print job of the printer control unit 103 according to the present invention.

First, in FIG. 13, a loop is entered (S1301) until an activation packet is received, and when an activation packet is received, it is determined (S1302) whether or not the power-saving status is entered. The reception of an activation packet corresponds to the reception of an activation packet in S1205 shown in FIG. 12.

In the determination in S1302, when the power-saving status is entered, the power supply unit 208 is controlled and the second power supply line 209 is supplied (S1303), thereby restoring the second power status. It the power-saving status is not entered, the power supply unit 208 is not controlled.

Then, the timer is set (S1304), it is determined whether or not a print job is received (S1305), control is passed to the third power status when the print job is received, and the print job is processed. For example, the PDL is interpreted in the display list, the display list is expanded into bit map data (S1306), the timer is reset (S1307), and control is returned to S1304.

Unless a print job is received, it is determined (S1308) whether or not a time set on the timer has passed. If it has not yet passed, the power supply unit 208 is controlled to stop (S1309) the supply of the second power supply line 209, and the power-saving status is entered, thereby returning control to the start of the process. Unless the time set by the timer has passed, control is returned to S1305.

As explained above, according to the present embodiment, it is not necessary for a user to be aware of the activation of a printer, and the printer can be activated by a magic packet having a high power-saving effect.

### Second Embodiment

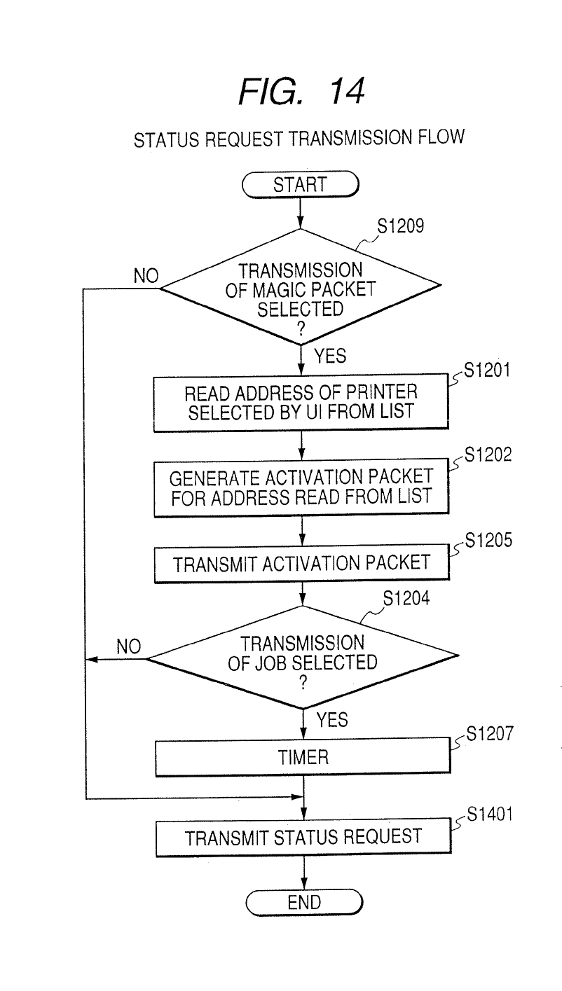

FIG. 14 is a flowchart for explanation of an embodiment of the present invention. In FIG. 14, the processes in S1201, S1202, S1204, S1205, S1207, S1209 are almost the same as the operations according to the first embodiment. The feature of the present embodiment is that, after transmitting the activation packet for activating the second interface unit, a status request packet requesting status information indicating the status of the printer control unit 103 is transmitted (S1202).

The request for status information can include a request for the status as to whether or not the communication facility of the second interface unit has been established, and a request for the status of the printer as to whether or not the status (no paper, no toner, etc.) of normally printing is entered.

As described above, it is possibly necessary for the printer control unit 103 to confirm whether or not the status indicates a normal condition of the printer control unit before transmitting a print job from the host computer, or whether or not a print job can be input. However, although the printer is in the first power status, the printer control unit can be activated without a user being aware of the status, and the print job can be normally input and allowing the printer (including the printer control unit) to print data.

### Third Embodiment

In the third embodiment, the power-saving system according to the first and second embodiments is described further in detail. The system of designating the user-desired network power control performed externally (a host computer, an operation panel of a printer) is explained below. In the third embodiment, the basic configurations and functions are similar to those in the first and second embodiment, and the explanation of the similar portions is omitted here.

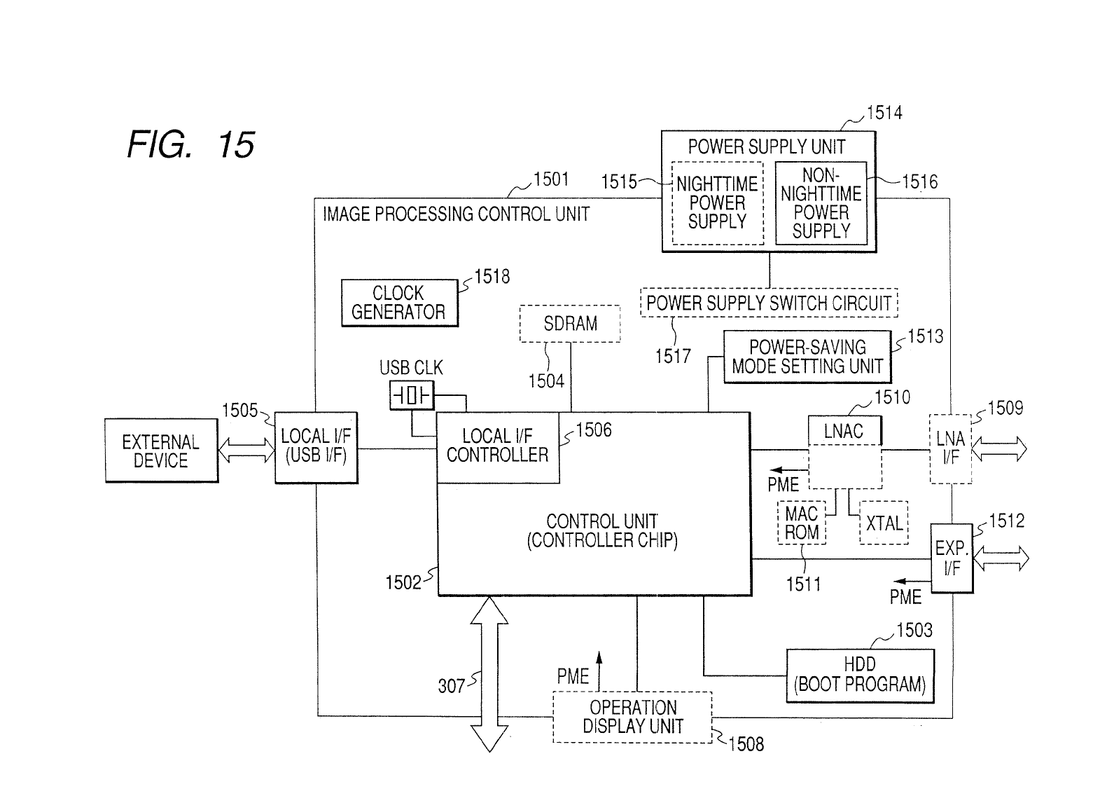

FIG. 15 shows the details of the printer control unit 103 according to the first and second embodiments of the present invention, and an image processing control unit 1501 corresponds to the printer control unit 103 according to the first and second embodiments.

The image processing control unit 1501 includes a control unit (controller chip) 1502 (corresponding to the control unit 203 shown in FIG. 2) realized on one chip for controlling the entire control unit. The control unit 1502 is configured by a ROM I/F storing various programs not shown in the attached drawings, an RMA (including DRAM) I/F, a PCI bus I/F, a Video I/F function, expanding hardware for a printing description language transferred from any external device, and an ASIC including compressing and decompressing functions of various data.

The control unit 1502 has the function of performing initializing process on print data received from the external device through a network and a LAN controller 1510 (corresponding to the network interface unit 202 shown in FIG. 2), and the function of processing data passed through the LAN controller 1510. The control unit 1502 applies to the control unit 203 and can correspond to the second interface explained in the first and second embodiments.

A hard disk 1503 is a hard disk (corresponding to the memory unit 205 in FIG. 2) which is non-volatile storage means continuously holding data although main power is not supplied.

The hard disk 1503 stores an initialization program for each unit of the image processing control unit 1501, an initial value (parameter) relating to image processing, communications, display, etc., and a program defining various operations of image processing, communications, display, etc. According to the present embodiment, the data relating to the initialization stored in a hard disk can be referred to as initialization data or setting data.

When the main power switch is turned on for the body of the printer, the execution of the boot program stored in the hard disk 1503 is started, and a initialization program, an initial value (parameter), and a main program are read from the hard disk 1503 by the image processing control unit 1501 including the control unit 1502, thereby performing the initializing process.

SDRAM 1504 (corresponding to the memory unit 205) temporarily stores expanded print data by the control unit 1502, and temporarily saves various initial values and various programs read from the hard disk 1503 when the initializing process is performed depending on the transfer to the deep sleep described later. Various saved initial values and programs are reused by each unit when the deep sleep is restored, and a high-speed restoration can be performed when power is applied again to each unit.

The SDRAM 1504 can also be replaced with DDR-SDRAM, SRAM, etc. Generally, as compared with non-volatile storage means such as a hard disk, EEPROM, flash memory, etc. volatile storage means is higher in data reading/writing speed, and it is desired that the volatile storage means is assigned to the print job delay check box 604. Especially, when a program is large in data size, it is necessary to store the program in the hard disk due to the restriction on the data size in the ROM. In this case, a high-speed process by volatile storage means is emphasized.

A USB interface 1505 is connected to a local I/F controller 1506 contained in the control unit 1502 through a bus, and the local I/F controller 1506 is built in the control unit 1502. The local I/F controller functions as local communications control for performing a receiving process of data transmitted from an external device through a local interface.

Since the power supply to the local I/F controller 1506 depends on the control unit 1502, the power supply to the local I/F controller 1506 is cut off when the control unit 1502 itself is turned off. The local I/F controller 1506 also has the function of recognizing whether or not the external device is connected such that it can communicate data through the USB interface 1505. It is also possible to provide the local I/F controller 1506 outside the control unit 1502.

A nighttime power supply is applied to an operation display unit 1508 of a printer so that a user can confirm the status of a printer including the image processing control unit 1501 and can change the settings relating to various image processing. A nighttime power supply refers to a power supply functioning as what is called a secondary power supply (corresponding to the first power supply line 210 shown in FIG. 2) which is not cut off in the deep sleep status described later when the main power supply is turned on by a hard switch. On the other hand, a non-nighttime power supply refers to a power supply functioning as what is called a main power supply (corresponding to the second power supply lines 209, 214, etc. shown in FIG. 2) which is cut off under a predetermined condition in the deep sleep status described later although the main power supply is turned on. For example, when the image processing is performed by the control unit 1502, the main power supply (non-nighttime power supply) is used.

An activation signal (PME in FIG. 15) for recovery of the image processing control unit 1501 from the deep sleep status explained in detail later depending on the operation on the operation display unit 1508 is issued. The PME is short for power management event, and is used in indicating the power-up of a system. The PME can be received by a system loaded with a bus in accordance with the PCI2.2 standards. However, the present invention is not limited to this PME, but can be applied to any instruction signal capable of indicating power-up. The PME can correspond to the activation signal 212 explained above by referring to the first and second embodiments.

The LAN (local area network) I/F 1509 is interface means for performing various data communications with a plurality of external devices (can be referred to as a host computer or an information processing device), and can adopt, for example, a 10/100 BASE-T connector.

The reference numeral 1510 designates a LAN controller (corresponding to the network interface unit 202 shown in FIG. 2), and controls the communications with an external device through the LAN I/F 1509. The LAN controller 1510 comprises dotted line portions (the internal bus interface unit 301, the reception buffer unit 304, the reception control unit 305, the monitor unit 306, or those corresponding to a part of them shown in FIG. 2) to which nighttime power supply is applied, and non-dotted-line portions (corresponding to, for example, the transmission buffer unit 302, the reception control unit 305, etc.) to which non-nighttime power supply is applied.

The dotted line portion in the LAN controller 1510 functions as a monitor unit (corresponding to the reception control unit 305 and the monitor unit 306 shown in FIG. 2) for monitoring whether or not data of any of a plurality of patterns has been received in response to an inquiry from an external unit through the LAN I/F 1509. The plurality of patterns include at least the first activation instruction including the identification information specifying the print control apparatus explained by referring to the first and second embodiments.

The non-dotted-line portion in the LAN controller 1510 functions as a communications unit. When any pattern is recognized by the monitor unit, an activation signal (the PME signal shown in FIG. 15) is issued for recovery of the control unit 1502 from the deep sleep status. When the PME activation signal is issued, the non-nighttime power supply is applied, and control is passed to the second power supply status. Then, the dotted line portion in the LAN controller 1510 is made to correspond to the first interface in the first and second embodiments, and the non-dotted-line portions of the LAN controller together with the other portions correspond to the second interface.

The plurality of patterns are registered in MAC ROM 1511 (corresponding to the settings of the activation condition to the monitor unit 306), and is read by the LAN controller 1510 when the initializing process is performed. The non-nighttime power supply can be applied to the MAC ROM 1511. The MAC ROM 1511 can store a plurality of specific data patterns as monitor targets so far as a predetermined capacity is not exceeded.

As practical examples of an activation condition registered in the monitor unit explained above by referring to the first and second embodiments, as a plurality of patterns, for example, there can be (1) a pattern of an ARP (address resolution protocol) packet whose target IP address is the IP address of the home apparatus, (2) a multicast packet, a broadcast packet, etc. having a pattern including communications information addressed to a non-specific device, a unique identifier for use in power supply control. That is, a non-specific device as a destination refers to a plurality of printers as destinations by adopting a multicast address, a broadcast address, etc.

The explanation is given below by referring to the correspondence with the first and second embodiments. The destination IP address in the ARP packet in (1) is made to correspond to the destination address field 701 shown in FIG. 7, and the pattern of the ARP packet (a combination of a frame time, a protocol ID, and a destination port number) can correspond to the data pattern of the 704 and 705. The communications information using a non-specific device in (2) as a destination can make the destination 701 explained by referring to FIG. 7 correspond to the broadcast address, and the unique identifier used in power supply control correspond to the data pattern 704 and 705.

Described below is the deep sleep according to the present embodiment. The image processing control unit 1501 having the configuration shown in FIG. 15 applies nighttime power supply to the minimal portions required to recover from the status in which print data cannot be received from an external device in each block in the image processing control unit 1501 such as the SDRAM 1504, the operation display unit operation display unit 1508, an extension interface 1512, the LAN controller 1510, the LAN I/F 1509, a power supply switch circuit 1517, etc., or processed, or in which no reply can be made to a status request unless an interrupt signal is detected for a predetermined time after a timer is activated, and cuts off the power supply to other function blocks. This corresponds to the first power status 401 explained by referring to FIG. 4 according to the first and second embodiments. In the present embodiment, the first power status in the first and second embodiments is referred to as the deep sleep status and explained below.

The communications information can be, for example, the information for data communications such as a destination Ether address of Ether Frame, a destination IP address of IP Frame, a source port number, a destination port number, etc.

A unique identifier for use in power supply control can be, for example, what can be interpreted as a pattern of a trigger for recovery of a printer from the deep sleep such as an operation code, a specific character string, etc.

Not only a printer but also a host computer is provided with a generation unit (an application, a communications module, a printer driver, etc.) for generating a unique pattern.

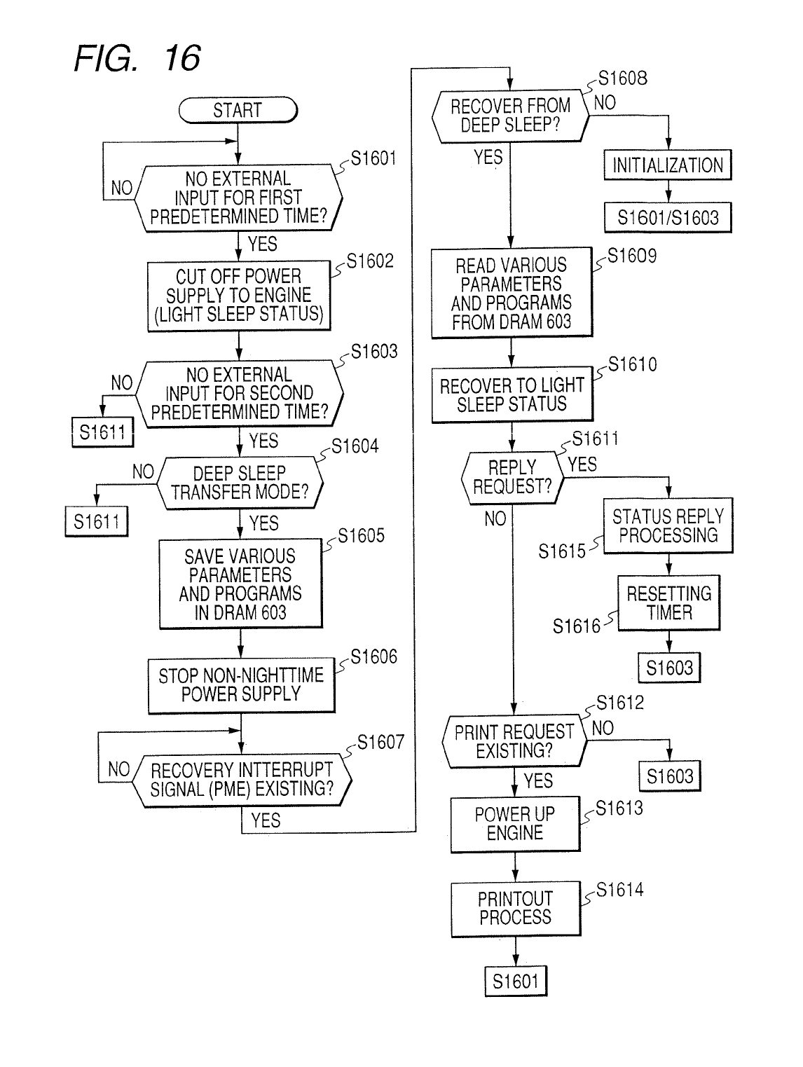

A power supply unit 1514 includes nighttime power supply 1515 and non-nighttime power supply 1516. The nighttime power supply 1515 is a supply to a dotted line block shown in FIG. 16 in the deep sleep status described later. When the image processing control unit 1501 recovers from the deep sleep status, power is supplied to the non-dotted-line block shown in FIG. 15 from the non-nighttime power supply 1516.

The power supply switch circuit 1517 has the function of controlling the supply of power to each block from the nighttime power supply 1515 or the non-nighttime power supply 1516 included in the power supply 1514. For example, a configuration of supplying power when a deep sleep activation signal is input using an FET (field effect transistor) IC chip can realize an operation with lower power supply.

Switching process is performed such that power can be applied to each non-dotted-line block shown in FIG. 15 from the nighttime power supply 1515 when the power supply activation instruction signal (PME) issued from the operation display unit 1508, the extension interface 1512, the LAN controller 1510, etc. is input to the power supply switch circuit 1517, and a power supply activation signal is applied from any block to a power supply switch circuit.

FIG. 16 is a flowchart of the process performed by the control unit 1502, and corresponds to the detailed process of the network interface unit 202 according to the first and second embodiments.

First, in step S1601, it is determined whether or not there is any external input for a first predetermined time (for example, for 5 minutes). External input can be, for example, print data (print request), etc. If it is determined “NO”, the determining process in step S1601 is repeated until the first predetermined time has passed.

The determining process in step S1601 can be the process of monitoring the occurrence of an event. That is, an event issued when the first predetermined time passes is monitored.

As a case in which it is determined “YES” in step S1601, there is an issue of a command to forcibly pass control from the 1508 and the extension interface 1512 to light sleep (explained later in detail), and various conditions can be applied.

If YES in step S1601, the power supply to a printer engine is suppressed in step S1602. The power saving to the printer engine can be cutoff or reduction in power supply to an extent of maintaining preheat of a printer engine. The power status attained in step S1602 is referred to as light sleep. For example, the second power supply status in the first and second embodiments corresponds to the light sleep.

In step S1603, it is determined whether or not there is external input for a second predetermined time (for example, for another 5 minutes after the passage of the first predetermined time). External input can be, for example, a request for various statuses of a printer, print data, instruction input, etc. through an operation display unit.

As a case in which it is determined “YES” in step S1603, there is an issue of a command to forcibly pass control from the 1508 and the extension interface 612 to deep sleep.

When it is determined YES in step S1603, it is determined in step S1604 whether or not the setting are made to pass control to the deep sleep mode. The determination is realized by any block of the control unit 1502 or the image processing control unit 1501 referring to a flag stored in the power-saving mode setting unit 1513. A power-saving mode setting unit 1513 holds the setting as to whether or not control is passed to the deep sleep mode.

On the other hand, if it is determined NO in steps S1603 and S1604, control is passed to step S 1611, and external access is monitored by the LAN controller 1510.

On the other hand, if it is determined YES in step S1604, then various parameters and the initialization data of various main programs, etc. read by the image processing control unit 1501 (or the control unit 1502) during the initializing process are saved in the SDRAM 1504 for a high-speed recovery in step S1605. When power supply control is performed to stop the local I/F controller 1506 (local communications control means), the setting data to the local communications control means is also temporarily saved by saving means in storage means.

When the saving process in the SDRAM 1504 is completed, the power supply from the non-nighttime power supply 1516 is cut off in step S1606. Practically, a switching signal is transmitted to the power supply switch circuit 1517 to cut off the power supply from the non-nighttime power supply, the power supply switch circuit 1517 operates, and the power supply from the non-nighttime power supply is stopped. Thus, the power supply to the non-dotted-line portion shown in FIG. 15 is cut off, and the image processing control unit 1501 enters the deep sleep status with the standby power of 1 W or less. Power saving is performed to stop the function of not only the control unit 1502, but also the non-dotted-line portion (communications control unit which passes external data to the control unit 1502) of the LAN controller 1510, thereby realizing a higher power-saving effect than by a communications unit.

In step S1607, event input to indicate the recovery from the deep sleep is monitored. Practically, the PME in FIG. 15 is input to the power supply switch circuit 1517, and it is determined YES in step S1607. The event monitoring process in step S1607 can be realized by the hardware configuration as the power supply switch circuit 1517, and by software.

When it is determined YES in step S1607, it is determined in step S1608 whether or not a recovery from deep sleep can be performed. As compared with the first and second embodiments, the recovery from deep sleep in step S1608 corresponds to the process in step S1303.

If it is determined YES in step S1608, various parameters saved in the SDRAM 1504 and the main program are read from the control unit 1502 in step S1609.

In step S1609, the read parameters include the configuration information written to the register unit of the local I/F controller 1506. For example, the USB version information, etc. is included. Thus, while saving the power supply of the local I/F (USB) controller 1506, it is not read again the initialization data from the HDD, etc. when the deep sleep is restored, thereby realizing a high-speed recovery.

In step S1610 after the process in step S1609, the power status is restored to the status of light sleep. In the light sleep status, communications can be performed with an external device through the LAN and the USB without operating the hard disk 1503 and the printer engine. At this time, power is applied also to the non-dotted-line portion (communications control unit for passing external data to the control unit 1502) of the LAN controller 1510.

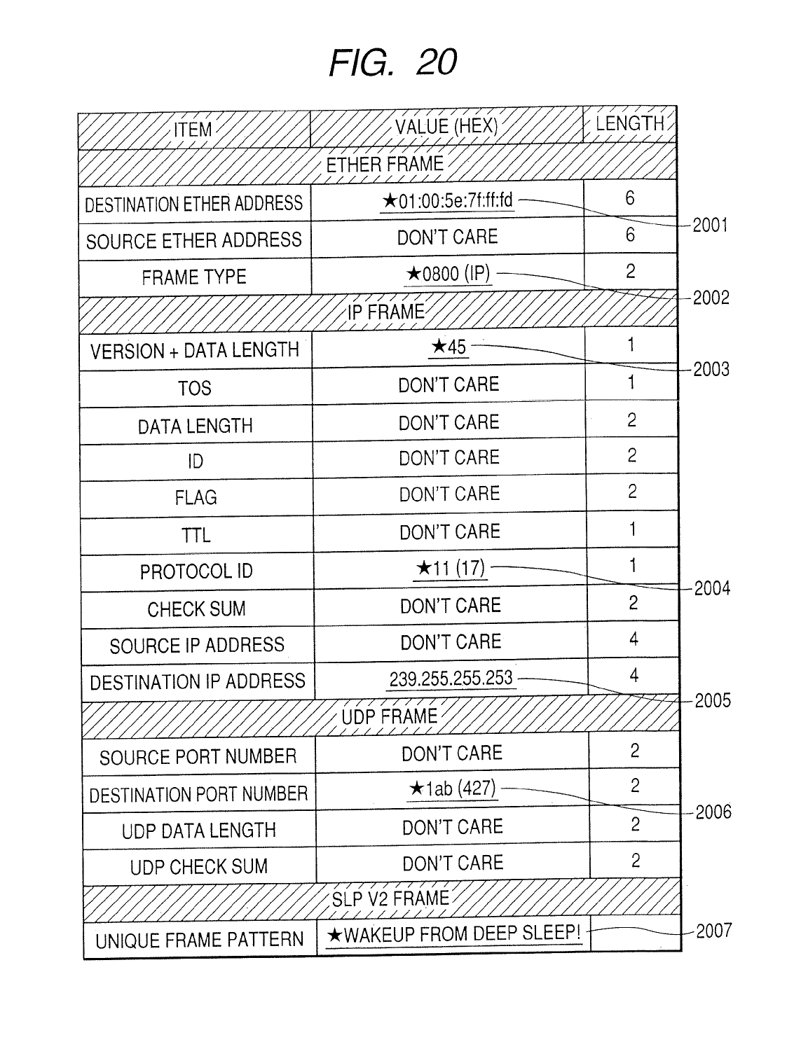

The recovery to the light sleep in step S1610 corresponds to the transfer to the status in which a reply can be made upon receipt of print data or in response to an external inquiry. After recovery to light sleep, the process after transfer to the subsequent step in step S1611 is performed at various commands from the external device. It is also possible to include a status request or a search and reply request instruction in a unique frame pattern explained by referring to FIG. 20.

In step S1611, it is determined whether or not a reply about the status of the printer has been received from an external device. If it is determined YES, then after performing the replying process in step S1615, the time is reset in step S1616, and control is returned to S1603. Depending on the reading speed and the amount of read data in the SDRAM, it may require several seconds to restore from deep sleep to light sleep. In this case, it is assumed that an external request cannot be immediately answered. However, by allowing an external device to retry the request or adopting the time explained by referring to FIGS. 12 and 14 according to the first and second embodiments, a status reply can be made from the external device to the printer as a result. As compared with the first and second embodiments, the determination YES in step S1611 corresponds to steps S901 and S903 shown in FIG. 9.

On the other hand, if it is determined NO in step S1611, it is further determined in step S1612 whether or not a print request has been received. If it is determined NO in step S1612, control is returned to S1603.

If it is determined YES in step S1612, power supply is controlled to supply power to the printer engine in step S1613, and various printout processing is performed in step S1614. After completing the printout processing in step S1614, control is returned to S1601 again. As compared with the first and second embodiments, the process of determining in step S1612 that there is a print request corresponds to the determination YES in step S1305 shown in FIG. 13. In FIG. 16, the timer is set in step S1304 as shown in FIG. 13, and a process can be performed based on the timer value although not explained above.

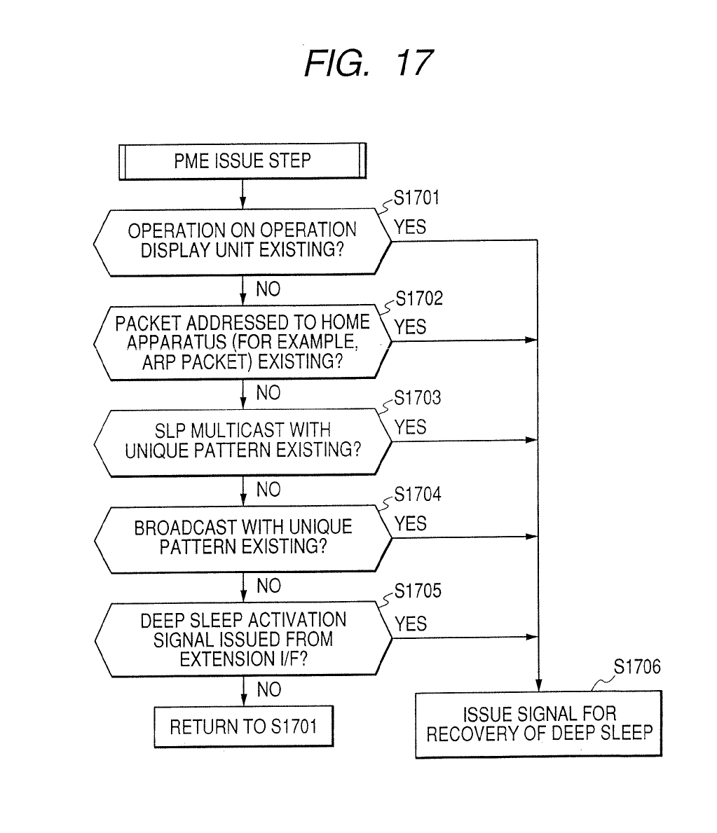

By referring to FIG. 17, the monitoring process up to the occurrence of a recovery signal from deep sleep including the monitoring process by the monitor unit of the LAN controller 1510 for monitoring the reception of data of any of plural types of patterns in response to an external inquiry is explained below. The flowchart shown in FIG. 17 can be performed in synchronization with the process in step S1607 shown in FIG. 16, and can also be concurrently performed as an independent routine. The process in each step in FIG. 17 is performed when an image processing control unit 1801 is in the deep sleep status. The step S1701 is performed depending on the operation on the operation display unit 1508 shown in FIG. 15. The processes in steps S1702 to S1705 correspond to the process performed by the LAN controller 1510 shown in FIG. 15. When a signal is issued in the process in step S1706, it is determined YES in step S1607 shown in FIG. 16. Each step is described below in detail.

First, in step S1701, it is determined whether or not any operation has been performed on the operation display unit. An operation on the operation display unit can be, a press of a button provided for the operation display unit, and a contact on the liquid crystal screen when the operation display unit is a liquid display panel.

If it is determined YES in the determining process in step S1701, power is supplied to the local I/F controller 1506 as a result. An external device connected through the local I/F 1505 is positioned near a printer, and it is not necessary to energize the local I/F controller 1506 for connection to the local interface without reducing usability, thereby further improving the power-saving effect.

In step S1702, it is determined whether or not a packet addressed to the home apparatus has been received. Whether or not it is addressed to the home apparatus depends on the IP address, the MAC address, the device serial number, the device name contained in a packet. A packet addressed to the home apparatus can be an ARP packet.

In step S1703, it is determined whether or not there is an SLP multicast packet including a unique pattern has been received. A unique pattern is described in the extended portion of an SLP multicast packet, and data with an embedded unique pattern can appropriately be target data in step S1703. The destination address of the SLP packet shown in FIG. 20 can be a broadcast address.

In step S1704 it is determined whether or not there is a broadcast data containing a unique pattern has been received. In this case, broadcast data with an embedded unique pattern can be target data in step S1704.

In step S1705, it is determined whether or not there has been a PME signal issued through the extension interface 1512. For example, when a network interface card (not shown in the attached drawings) is connected through the extension interface 1512, a PME signal can be issued from the extension interface 1512 by providing the function similar to the 1509 and the LAN controller 1510 shown in FIG. 15. An INT signal from the network interface card (not shown in the attached drawings) can be a monitor target.

In step S1706, a recovery signal from the deep sleep is issued. By performing the process in step S1706, it is determined YES in step S1607 shown in FIG. 16.

Thus, according to the flowchart shown in FIG. 17, in response to an external inquiry, the reception of data of any pattern in plural types of patterns including a pattern containing the communications information having a non-specific device as a destination (having a multicast address or a broadcast address) and an identifier used in power supply control is monitored, and when data of any pattern is received through the LAN I/F 1509 and the LAN controller 1510 (first interface means), power can be supplied to the control unit 1502.

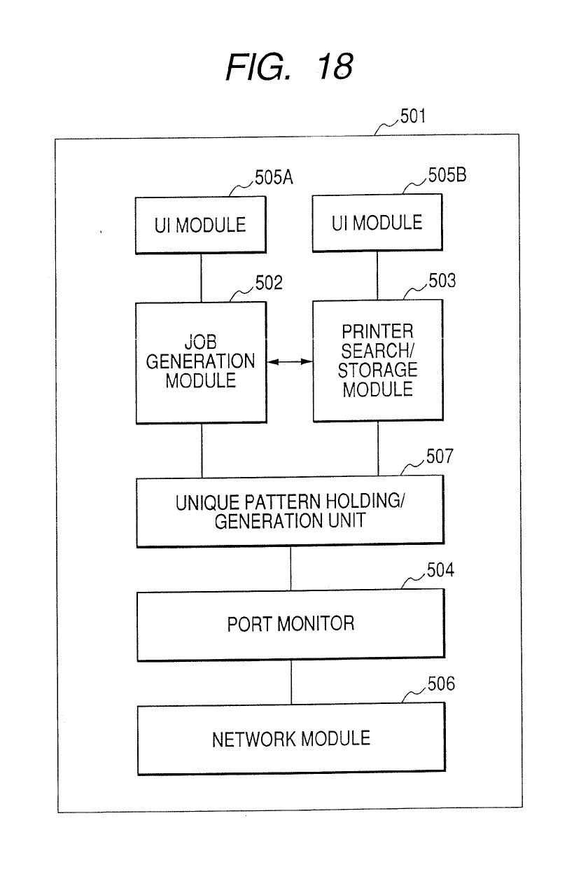

FIG. 18 is an explanatory view of an example of a variation of a print processing module shown in FIG. 5 explained by referring to the first and second embodiments. In the first and second embodiments, a magic packet as shown in FIG. 7 and a magic packet including the destination of a broadcast as an example of the activation instruction including the identification information specifying a printer to be created in the network module 506 are explained. FIG. 18 shows an example of a variation.

A function block having the same reference numeral has at least the function explained by referring to the first and second embodiments. The differences from the contents shown in FIG. 5 are mainly explained below.

In FIG. 18, the UI module 505A managing the UI display control of the job generation module and the UI module 5B managing the UI display control of the printer search/storage module are configured as different modules. It is obvious that, as in the first and second embodiments, one UI module can be designed.

A unique pattern holding/generation unit 507 holds information based on which a pattern determined in steps S1702 to S1704 shown in FIG. 17 is generated, and according to the held information, an activation instruction received on the printer in steps S1702 to S1704 is executed by the network module 506, and data based on a predetermined communications protocol is output.

As another example of a variation, a unique pattern holding/generation unit instruction unit can be included in the job generation module 502 and the printer search/storage module 503, and also in a port monitor and a network module.

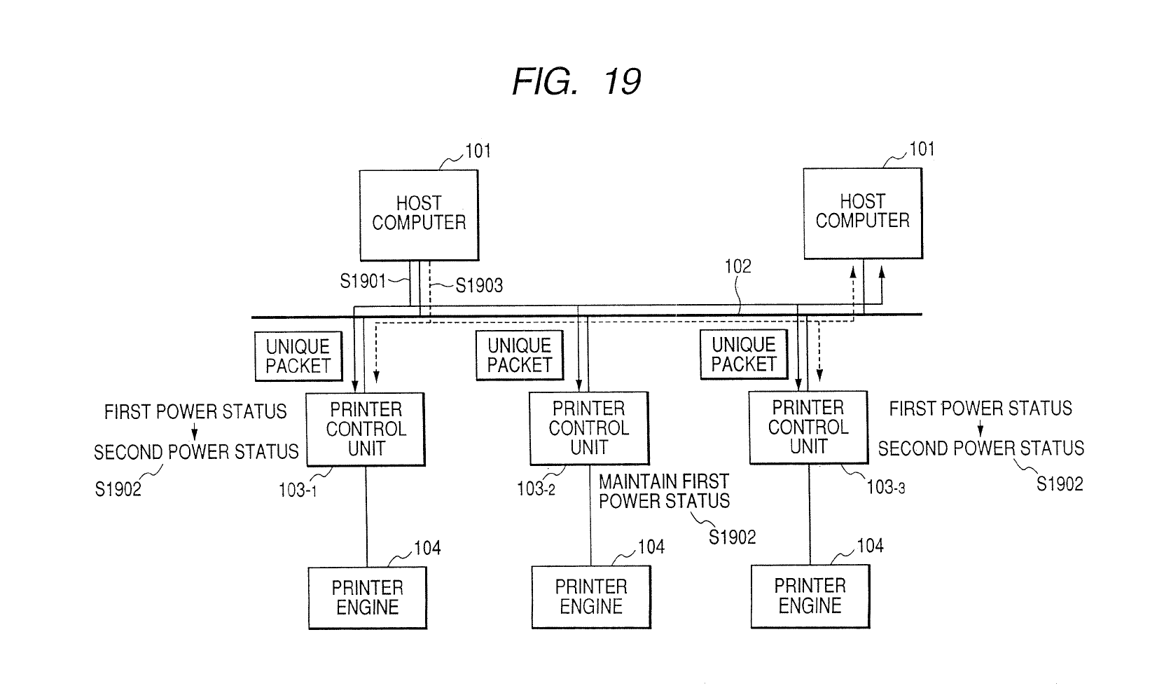

By referring to FIG. 19, the application process using a packet having a unique pattern as explained by referring to step S1703 shown in FIG. 17 is explained.

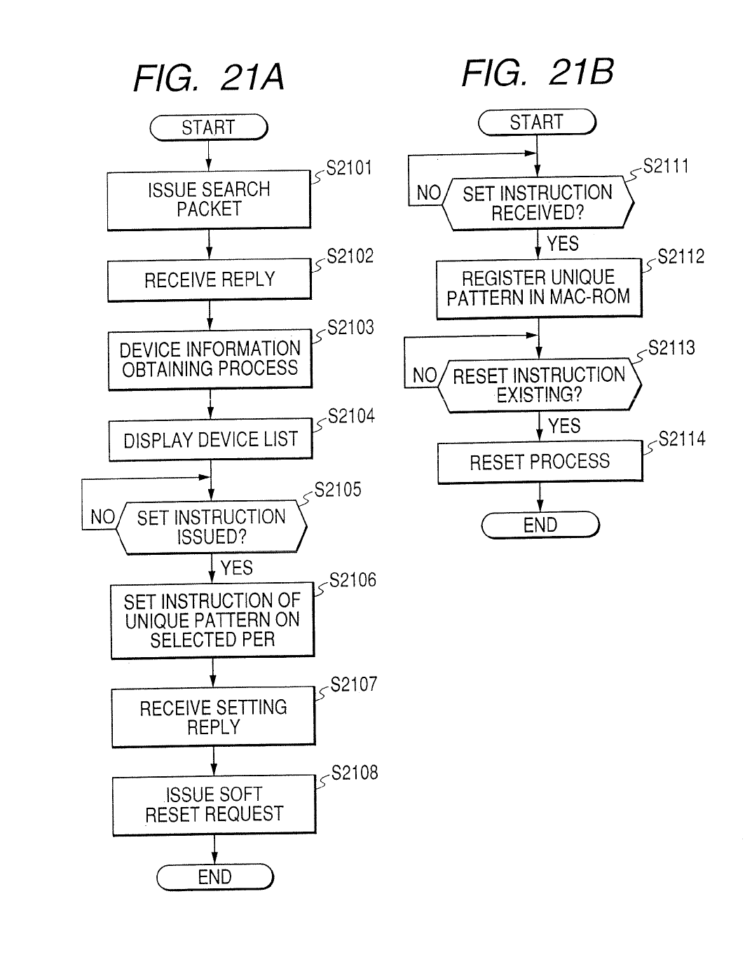

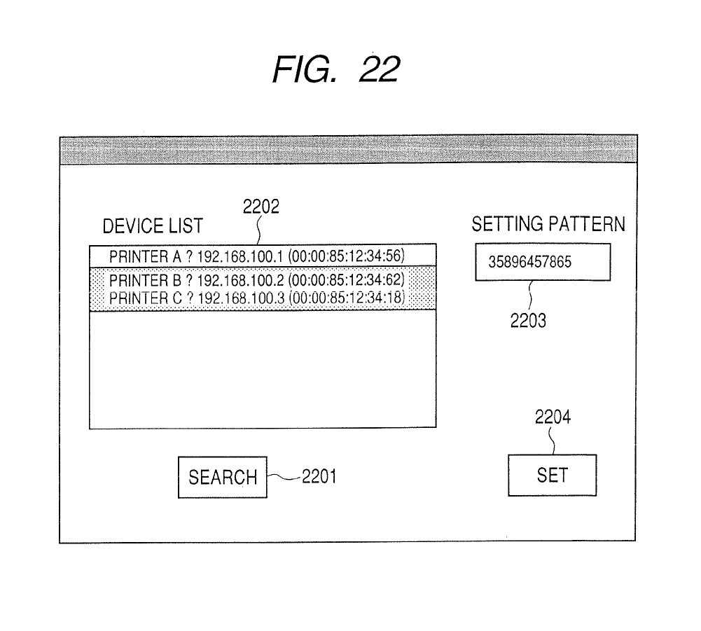

First, in step S1901, a packet (unique packet in FIG. 19) including a unique pattern having a non-specific device registered in advance in the printer control unit 103 as a destination, which is described later in detail by referring to FIG. 20, is issued from the host computer 101 over a network. The unique pattern shown in FIG. 19 can be user-customized, and is described in detail by referring to FIGS. 21 and 22.

When it is issued, the printer control unit 103 (corresponding to the image processing control unit 1501 shown in FIG. 15) performs the process explained by referring to FIGS. 16 and 17. That is, in step S1901, if a unique pattern contained in an issued packet has been registered in the MAC ROM 1511 in advance, then it is determined YES in step S1703 shown in FIG. 17.

In step S1902, the reception of data of any pattern in plural types of patterns including a pattern containing the communications information having a non-specific device as a destination and an identifier used in power supply control is monitored by each of the printer control units 103 as described in FIG. 17. When the data of any pattern is received through the LAN controller 1510 (corresponding to a part of the network interface unit 202 according to the first and second embodiments excluding the communications unit required for a status reply, etc.), power is supplied to a control unit 106 and the non-energized part of the network controller.

As a result, in each printer control unit 103, in the printer control unit determined YES in step S1703 shown in FIG. 17, power control is performed from the deep sleep status (first power status) to the light sleep (second power status). Then, as described above, by passing control to the light sleep as described above, a reply can be made in response to various requests from the host computer.

In step S1903, a well-known status request (request or various information) is made for each printer control unit. When the status request is made in a broadcast, the reply from the printer control unit 103 which has changed into the light sleep status (second power status) is transmitted to the host computer, and no reply is obtained from the printer control unit which maintains the deep sleep.

By performing the flowchart shown in FIG. 19, various well-known instructions can be issued from the host computer to a printer which has changed into the light sleep status (second power status), that is, a plurality of specific printers.

As well-known various instructions, input of a print job, registration of resource information such as font, etc., a change in settings of a printer device, the detailed status of a printer device, etc. can be assumed.

FIG. 20 shows an example of a pattern issued by a host computer and monitored by the LAN controller 1510 on the printer side in step S1901 shown in FIG. 19. FIG. 20 shows an example of a specific pattern using a non-specific device registered in advance in a print control apparatus as a destination.

In FIG. 20, reference numerals 2001 to 2006 refer to parameter items marked with stars designate service request packets of SLP (service location protocol) and a plurality of devices are destinations. Especially, an SLP packet can be identified by a destination port number 2006, but a pattern capable of identifying an SLP can be included in a frame pattern 2007. The reference numeral 2007 designates, a unique frame pattern which is an identifier for use in power supply control in the printer. The unique frame pattern can be optionally set by a printer providing side or a user side, and a device group assumed by the printer providing side or the user can be collectively used for recovery from the deep sleep. Thus, only necessary equipment can be searched for over the network, and a network can be searched when a printer driver is set up. Although only one item is indicated in the unique frame pattern 2007 shown in FIG. 20, a plurality of items are included in forming a unique frame pattern.

An external device can collectively activate a plurality of printers capable of interpreting the unique frame pattern 2007 by a simpler operation by an inquiry using the data as shown in FIG. 20 through a multicast to a plurality of printers.

A pattern including the communications information using a non-specific device as a destination and an identifier used in power supply control is not limited to an example of a pattern of an SLP packet example shown in FIG. 20, but can include a uniquely created unique identifier (unique frame pattern). In addition, for example, an identifier used in power supply control can be included in an item for identifying an SLP packet (communications information using a non-specific device as a destination). For example, the printer can be restored from the deep sleep status based on the interpretation of an imaginary value by setting the imaginary value as a “source port number” shown in FIG. 20.

Thus, by allowing the monitor unit of the LAN controller 1510 to monitor a plurality patterns, various instructions relating to the printing from an external device can be used. For example, by issuing an ARP packet when a print job is input to the printer using a printer driver, etc. from the external device loaded with Windows (registered trademark), the printer can be restored from the deep sleep in advance. When a plurality of printers are searched for in an external device over a network, the printer can be restored from the deep sleep and the search can be performed by issuing a broadcast and a multicast packet including unique data pattern. As a result, the power-saving effect can be improved on the control unit 1502 and the communications control unit (a part of the LAN controller 1510), and the usability of the printer can be maintained for the user.

FIGS. 21A and 21B show examples of flowcharts for explanation of the process of registering in the printer control unit 103 (MAC ROM 1511 shown in FIG. 15) the pattern including the communications information and an identifier for power supply control using a user desired non-specific device as a destination as explained above by referring to FIGS. 19 and 20. FIG. 21A shows the process on the host computer, and FIG. 21B shows the process on the printer.

First, the process on the host computer shown in FIG. 21A is explained. In response to the search instruction in the host computer (for example, corresponding to the press of a search button 2204 shown in FIG. 22), the host computer 101 issues a search packet including a unique frame pattern commonly registered in the MAC ROM 1511 of a plurality of printer over a network in step S2101. For example, when the unique frame pattern 2007 explained by referring to FIG. 20 is commonly registered in a plurality of printers, the host computer can issue data shown in FIG. 20 in step S2101.

In response to the issue of a search packet in step S2101, the status of each per changes from the first power status to the second power status.

In step S2102, a reply of a search packet issued in step S2101 from the printer control unit 103 of any of the plurality of printers is received. One or more printers which makes a reply.

In step S2103, a printer attribute such as a printer name and the status are obtained for each printer in the reply. The obtaining process in step S2103 can be realized by including a device information obtain request in the search packet in step S 2101.

In step S2104, the display control on the display unit is performed according to the device information obtained in step S2103. FIG. 22 shows an example of display on a display unit. In FIG. 22, three printers return replies, and three printers obtain device information.

In step S2104, it is determined whether or not a set instruction has been issued for the search button 2204 shown in FIG. 22. When it is determined YES in step S2104, a pattern input in a setting pattern input unit 2203 is transmit and set to one or more devices selected from a device list in step S2106.

In step S2107, a soft reset request is issued to one or more printers to which a reply indicating that the settings are accepted is received and the reply is made in response to the reception from one or more printers which issue a set instruction of a unique pattern in step S2106.

The process of the printer shown in FIG. 21B is explained. The important point is that the process shown in FIG. 21B is performed by each of the plurality of printers.

In step S2111, based on the process in step S2106, it is determined whether or not a set instruction of a unique pattern issued by the host computer has been received.

If it is determined YES in step S2111, the MAC ROM 1511 sets and registers the received unique pattern in step S2112.

In step S2113, it is determined whether or not there is a reset instruction. The reset instruction here corresponds to an issue of the soft reset request of S2108.

If it is determined YES in step S2114, a reset process is performed, and an initializing process is performed, and new settings become effective later.

In the case shown in FIG. 19, according to the flowchart shown in FIG. 21, a unique pattern is registered in advance in the printer control units 1301-1 and 1301-3.

On the other hand, a unique pattern issued by the host computer 102 is not registered in advance in the printer control unit 1301-2, and deep sleep (first power status) is maintained. As a result, a printer not desired by the user can be protected against useless recovery from deep sleep to light sleep, thereby realizing more efficient power-saving process.

Furthermore, by the process of the flowchart shown in FIG. 21, the printer control unit 103-2 shown in FIG. 19 can be restored from deep sleep to light sleep. That is, a unique pattern contained in a packet and issued in S1901 shown in FIG. 19 and contained in a packet, can be input through the user interface shown in FIG. 22, and the process of the flowchart shown in FIG. 21 can be performed.

FIG. 22 shows an example of the user interface for registration of a unique pattern in each printer control unit 103, and shows the display by the UI module 505B shown in FIG. 18.

In FIG. 22, a search button 2201 searches the printer control unit 103 on the network 102, and corresponds to the issue of a search packet in step S2101 shown in FIG. 21.

A printer list window 2202 displays a list of the printer control units 103 detected as a result of the search, and a set instruction of a unique pattern is issued by the host computer in step S2106 to a printer selected through a pointing device such as a mouse, etc.

A setting pattern input unit 2203 inputs a unique pattern, and an input unique pattern is set by the host computer to each printer.

In FIGS. 21 and 22, the host computer registers a unique pattern to the MAC ROM 1511 of the printer (printer control unit 103). However, the present invention is not limited to this application. For example, a unique pattern is input from an operation unit of each printer and can be registered in the MAC ROM 1511.

This application claims priority from Japanese Patent Applications No. 2003-412488 filed Dec. 10, 2003 and No. 2004-346344 filed on Nov. 30, 2004, which is hereby incorporated by reference herein.

1.-24. (canceled)

25. A print apparatus operable in a first power state and a second power state in which power consumption is higher than power consumption in the first power state, the print apparatus comprising:
a network interface which communicates with an information processing apparatus;
a memory which stores data temporarily;
a controller which processes data received by the network interface using the memory;
a print engine which prints an image based on one or more print data packets received by the network interface; and
a power supply which is capable of supplying power to the network interface, the memory, the controller, and the print engine,
wherein the power supply supplies power to the network interface and the memory but does not supply power to the controller and the print engine when the print apparatus is in the first power state, and supplies power to at least the network interface, the memory, and the controller when the print apparatus is in the second power state,
wherein the network interface receives, from the information processing apparatus, a predetermined data packet including a MAC (Media Access Control) address of the print apparatus, and then the one or more print data packets, and
wherein the power supply supplies power to the controller to cause the print apparatus being in the first power state to shift to the second power state, according to the receiving of the predetermined data packet including the MAC address by the network interface at the time when the print apparatus is in the first power state.

26. The print apparatus according to claim 25, wherein the controller, to which power has been supplied by the power supply according to the receiving of the predetermined data packet by the network interface at the time when the print apparatus is in the first power state, is configured to read data from the memory and configure the controller based on the read data, the data having been stored in the memory before the shifting of the print apparatus to the first power state and stored by the memory when the print apparatus is in the first power state.

27. The print apparatus according to claim 26, the power supply supplies power to the print engine after supplying power to the controller according to the receiving of the predetermined data packet by the network interface at the time when the print apparatus is in the first power state.

28. The print apparatus according to claim 27, wherein the power supply supplies power to the print engine according to the receiving of the one or more print data packets by the network interface after supplying power to the controller according to the receiving of the predetermined data packet by the network interface at the time when the print apparatus is in the first power state.

29. The print apparatus according to claim 25, wherein, when the print apparatus shifts from the second power state to the first power state, the controller writes data into the memory, the data referred to when the print apparatus shifts from the first power state to the second power state,
wherein the power supply stops supplying power to the controller to cause the print apparatus to shift from the second power state to the first power state after the writing, and
wherein a controller to which power has been supplied by the power supply according to the receiving of the predetermined data packet by the network interface at the time when the print apparatus is in the first power state reads the data from the memory and configures the controller in accordance with the read data, the data having been written into the memory and stored by the memory when the print apparatus is in the first power state.

30. The print apparatus according to claim 25, wherein the power supply supplies power to the controller to cause the print apparatus being in the first power state to shift to the second power state, according to the receiving of the predetermined data packet including the MAC address by the network interface at the time when the print apparatus is in the first power state, regardless of the receiving of the one or more print data packets by the network interface.

31. A print apparatus for printing in accordance with one or more print data packets, the print apparatus comprising:
a memory which stores data temporarily;
a controller which processes data using the memory;
a network interface which receives a predetermined data packet including a MAC (Media Access Control) address of the print apparatus from an information processing apparatus and then receives the one or more print data packets from the information processing apparatus after receiving the predetermined data packet, and
a print engine which prints in accordance with the one or more print data packets received by the network interface from the information processing apparatus; and
a power supply which is capable of supplying power to the network interface, the memory, the controller, and the print engine,
wherein the power supply supplies power to the controller, in accordance with the predetermined data packet which is received before the one or more print data packets by the network interface when the network interface and the memory are power-on and the controller and the print engine are power-off.

32. The print apparatus according to claim 31, wherein the controller stores configuration data of a device in the print apparatus into the memory before the power supply stops power supply to the controller without stopping power supply to the memory, and reads out the configuration data after the power supply supplies power to the controller in accordance with the received predetermined data packet.

33. The print apparatus according to claim 31, wherein the power supply supplies power to the controller while maintaining supplying power to the network interface and the memory, in accordance with the predetermined data packet which is received before the one or more print data packets by the network interface when the network interface and the memory are power-on and the controller and the print engine are power-off.

34. The print apparatus according to claim 31, wherein the network interface transmits a predetermined reply packet to the information processing apparatus in response to the predetermined data packet which is received before the one or more print data packets by the networks interface when the network interface and the memory are power-on and the controller and the print engine are power-off.

35. The print apparatus according to claim 33, wherein the network interface receives the one or more print data packets from the information processing apparatus after transmitting the predetermined reply packet to the information processing apparatus in response to the predetermined data packet.
